(19) United States
(12) Patent Application Publication
(10) Pub. No.: US 2024/0143344 A1
(43) Pub. Date: May 2, 2024

(54) DYNAMIC PLUGIN SYSTEM AND METHOD FOR LOW CODE APPLICATION BUILDER

(71) Applicant: RAKUTEN SYMPHONY SINGAPORE PTE. LTD., Singapore (SG)

(72) Inventors: Steve CAMPOS, Montpellier (FR); Corentin ALLEMAND, Montpellier (FR)

(73) Assignee: RAKUTEN SYMPHONY SINGAPORE PTE. LTD., Singapore (SG)

(21) Appl. No.: 17/973,594

(22) Filed: Oct. 26, 2022

(51) Int. Cl. G06F 9/445; G06F 8/65

(52) U.S. Cl. CPC G06F 9/44526; G06F 8/65

(57) ABSTRACT

A method of implementing plugins in a low-code application, performed by at least one processor, includes receiving, from a user equipment (UE), parameters defining a first plugin, generating a first package defining the first plugin based on the received parameters, and generating the first plugin based on the first package.

### BACKGROUND

### 1. Field

Apparatuses and methods consistent with example embodiments of the present disclosure relate to plugins for low-code applications.

### 2. Description of Related Art

In the related art, a low-code application (App) building platform allows a user, who may not have experience or skill in coding, to build an App by, for example, pre-configured elements on a graphical user interface (GUI). A low-code App building platform may include pre-configured functional elements, such as buttons, labels, templates, etc., so as to allow a user to build an application by, for example, drag-and-drop of desired functional elements, with simplicity.

### SUMMARY

According to embodiments, systems and methods are provided for implementing plugins in a low-code application.

According to an aspect of the disclosure, a method of implementing plugins in a low-code application, performed by at least one processor, may include receiving, from a user equipment (UE), parameters defining a first plugin, generating a first package defining the first plugin based on the received parameters, and generating the first plugin based on the first package.

According to an aspect of the disclosure, a system for implementing plugins in a low-code application may include at least one memory storing instructions, and at least one processor configured to execute the instructions to receive, from a UE, parameters defining a first plugin, generate a first package defining the first plugin based on the received parameters, and generate the first plugin based on the first package.

According to an aspect of the disclosure, a non-transitory computer-readable storage medium may store instructions that, when executed by at least one processor, cause the at least one processor to receive, from a UE, parameters defining a first plugin, generate a first package defining the first plugin based on the received parameters, and generate the first plugin based on the first package.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of an example environment in which systems and/or methods, described herein, may be implemented;

FIG. 2 is a diagram of example components of a device according to an embodiment;

FIG. 3 is a diagram of an example of a search box plugin, according to an embodiment;

FIG. 4 is a diagram of a low-code application system, according to an embodiment;

FIG. 5 is a diagram of dynamic loading, according to an embodiment; and

FIG. 6 is a flowchart of a method of implementing plugins in a low-code application, according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

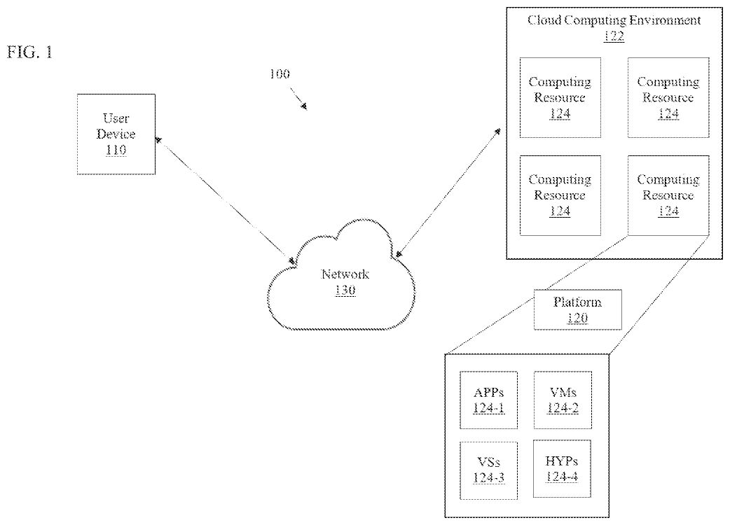

FIG. 1 is a diagram of an example environment 100 in which systems and/or methods, described herein, may be implemented. As shown in FIG. 1, environment 100 may include a user device 110, a platform 120, and a network 130. Devices of environment 100 may interconnect via wired connections, wireless connections, or a combination of wired and wireless connections. In embodiments, any of the functions and operations described with reference to FIG. 1 above may be performed by any combination of elements illustrated in FIG. 1.

User device 110 includes one or more devices capable of receiving, generating, storing, processing, and/or providing information associated with platform 120. For example, user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 110 may receive information from and/or transmit information to platform 120.

Platform 120 includes one or more devices capable of receiving, generating, storing, processing, and/or providing information. In some implementations, platform 120 may include a cloud server or a group of cloud servers. In some implementations, platform 120 may be designed to be modular such that certain software components may be swapped in or out depending on a particular need. As such, platform 120 may be easily and/or quickly reconfigured for different uses.

In some implementations, as shown, platform 120 may be hosted in cloud computing environment 122. Notably, while implementations described herein describe platform 120 as being hosted in cloud computing environment 122, in some implementations, platform 120 may not be cloud-based (i.e., may be implemented outside of a cloud computing environment) or may be partially cloud-based.

Cloud computing environment 122 includes an environment that hosts platform 120. Cloud computing environment 122 may provide computation, software, data access, storage, etc. services that do not require end-user (e.g., user device 110) knowledge of a physical location and configuration of system(s) and/or device(s) that hosts platform 120. As shown, cloud computing environment 122 may include a group of computing resources 124 (referred to collectively as “computing resources 124” and individually as “computing resource 124”).

Computing resource 124 includes one or more personal computers, a cluster of computing devices, workstation computers, server devices, or other types of computation and/or communication devices. In some implementations, computing resource 124 may host platform 120. The cloud resources may include compute instances executing in computing resource 124, storage devices provided in computing resource 124, data transfer devices provided by computing resource 124, etc. In some implementations, computing resource 124 may communicate with other computing resources 124 via wired connections, wireless connections, or a combination of wired and wireless connections.

As further shown in FIG. 1, computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

Application 124-1 includes one or more software applications that may be provided to or accessed by user device 110. Application 124-1 may eliminate a need to install and execute the software applications on user device 110. For example, application 124-1 may include software associated with platform 120 and/or any other software capable of being provided via cloud computing environment 122. In some implementations, one application 124-1 may send/receive information to/from one or more other applications 124-1, via virtual machine 124-2.

Virtual machine 124-2 includes a software implementation of a machine (e.g., a computer) that executes programs like a physical machine. Virtual machine 124-2 may be either a system virtual machine or a process virtual machine, depending upon use and degree of correspondence to any real machine by virtual machine 124-2. A system virtual machine may provide a complete system platform that supports execution of a complete operating system (“OS”). A process virtual machine may execute a single program, and may support a single process. In some implementations, virtual machine 124-2 may execute on behalf of a user (e.g., user device 110), and may manage infrastructure of cloud computing environment 122, such as data management, synchronization, or long-duration data transfers.

Virtualized storage 124-3 includes one or more storage systems and/or one or more devices that use virtualization techniques within the storage systems or devices of computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 124-4 may provide hardware virtualization techniques that allow multiple operating systems (e.g., “guest operating systems”) to execute concurrently on a host computer, such as computing resource 124. Hypervisor 124-4 may present a virtual operating platform to the guest operating systems, and may manage the execution of the guest operating systems. Multiple instances of a variety of operating systems may share virtualized hardware resources.

Network 130 includes one or more wired and/or wireless networks. For example, network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

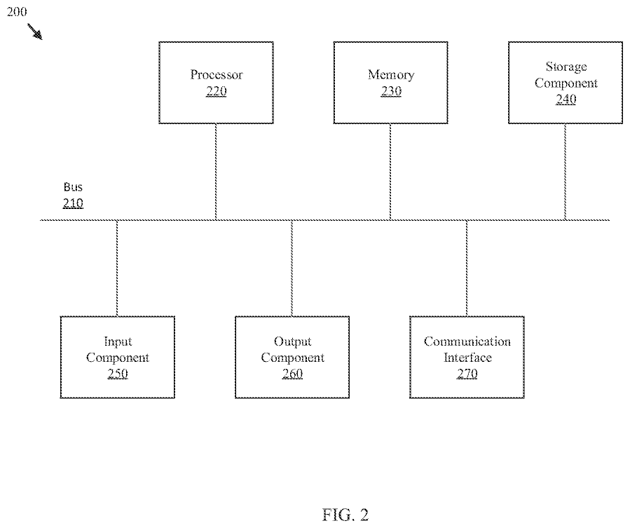

FIG. 2 is a diagram of example components of a device 200. Device 200 may correspond to user device 110 and/or platform 120. As shown in FIG. 2, device 200 may include a bus 210, a processor 220, a memory 230, a storage component 240, an input component 250, an output component 260, and a communication interface 270.

Bus 210 includes a component that permits communication among the components of device 200. Processor 220 may be implemented in hardware, firmware, or a combination of hardware and software. Processor 220 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 220 includes one or more processors capable of being programmed to perform a function. Memory 230 includes a random access memory (RAM), a read only memory (ROM), and/or another type of dynamic or static storage device (e.g., a flash memory, a magnetic memory, and/or an optical memory) that stores information and/or instructions for use by processor 220.

Storage component 240 stores information and/or software related to the operation and use of device 200. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 250 includes a component that permits device 200 to receive information, such as via user input (e.g., a touch screen display, a keyboard, a keypad, a mouse, a button, a switch, and/or a microphone). Additionally, or alternatively, input component 250 may include a sensor for sensing information (e.g., a global positioning system (GPS) component, an accelerometer, a gyroscope, and/or an actuator). Output component 260 includes a component that provides output information from device 200 (e.g., a display, a speaker, and/or one or more light-emitting diodes (LEDs)).

Communication interface 270 includes a transceiver-like component (e.g., a transceiver and/or a separate receiver and transmitter) that enables device 200 to communicate with other devices, such as via a wired connection, a wireless connection, or a combination of wired and wireless connections. Communication interface 270 may permit device 200 to receive information from another device and/or provide information to another device. For example, communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

Device 200 may perform one or more processes described herein. Device 200 may perform these processes in response to processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may cause processor 220 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

A low-code application building platform may allow a user without programming experience or skills to build an application, such as by dragging-and-dropping pre-configured elements on a graphical user interface (GUI). Application building platforms may include two main modules: an application studio with which a user is interacting, and an application builder that builds an application based on the user's input. In particular, the application studio may include predefined elements (e.g., a button, a table, etc.) with which a user may interact, where each of the predefined elements has an associated code/artifact. The predefined elements may include different levels such as a first-level element indicating the basic building blocks (e.g., fonts, tags, color palettes, buttons, etc.) a second-level element indicating a combination of the first-level elements, a third-level element indicating a combination of the second-level elements, etc.

The predefined interactive elements may be provided by the application studio in different levels (e.g., from predefined icon to predefined templates), or the user may use the application studio to build their intended interactive elements from the lowest-level elements (e.g., combine a plurality of atom-level icons to form a molecule-level element, etc.). These multi-level elements concept provide flexibility for a user to customize their application.

After the user has completed the design of the intended application on the application studio, the application studio may collect the information of each interactive element and build an application descriptive file representing the intended application (e.g., intended design, function, etc.). The application studio may then provide the application descriptive file to the application builder. The application builder may then generate an application based on the provided application descriptive file.

In order to allow the user to observe the application (e.g., how the application will appear) before building it, a low-code application builder may provide a preview of each of the functional elements on the screen. Each of the functional elements displayed on the screen preview is associated with a corresponding source code(s) defining the function/feature of the respective functional element (e.g., referred to as “dependency”).

The pre-configured functional elements included in a low-code application builder may be limiting. In that case, a plugin may be added to the low-code application builder in order to provide additional functions and/or features. Examples of plug-ins may include a search box, a video player, a post list from social platform, a graphical presentation tool (e.g., chart, histogram, etc.), etc. The plugin may include programming code indicating the dependencies of each intended feature, and each of the elements may be associated with a respective dependency description.

The application builder may include a preview window and a dependency library. The dependency library includes elements to be previewed on the preview window (e.g., a figure, etc.), and each of the elements is associated to a respective dependency description.

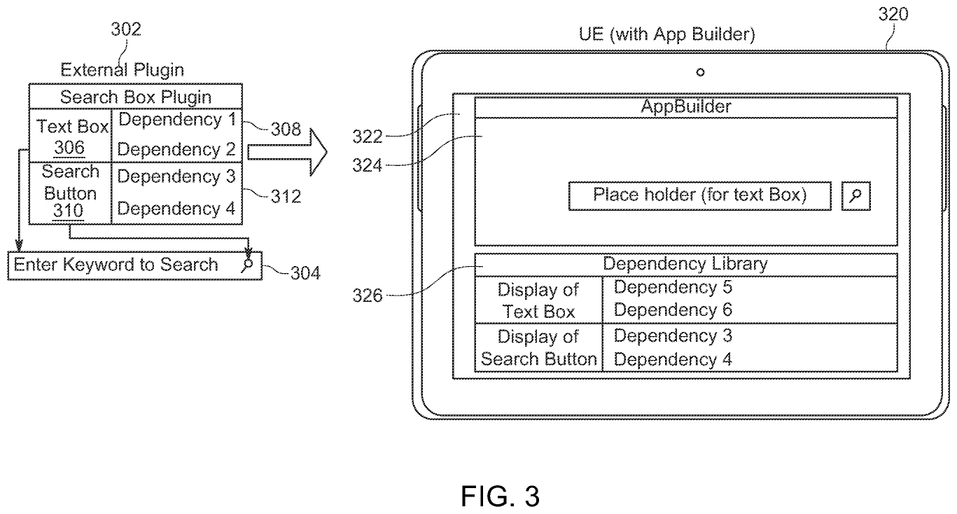

FIG. 3 is a diagram of an example of a search box plugin, according to an embodiment. As shown in FIG. 3, the external plugin 302 may be directed to a search box 304, with the text box 306 having corresponding dependencies 308, and the search button 310 having corresponding dependencies 312. A user equipment (UE) 320 may include a display 322 that shows a preview window 324 and dependency library 326. The dependency library 326 includes elements, such as the search box 304, to be previewed in the preview window 324. After the plugin 302 is added to the application builder, when a user wants to preview the plugin 302 in the preview window 324, the user may select the plugin 302 by, for example, dragging-and-dropping the plugin from a list to the preview window 324.

The system may determine, based on the dependency of the plugin 302, the elements associated with the plugin 302 and present the elements on the preview window 324. For example, the system may determine, from the plugin programming code, the dependencies of the “text box” and the “search button” based on the dependencies in a dependency library, an image of the “text box” and an image of the “search button.” The system may retrieve the determined images (e.g., from a storage) and present the images in the preview window 324.

Since a plugin may not be originally included in the low-code application builder, the components of the plugin may not have appropriate or compatible dependencies in the low-code application builder. In that case, the plugin may not be accurately presented in the preview window 324, or may not be presented in the preview window 324.

Conventionally, such an issue may be addressed by using a placeholder (e.g., a text box) representing the plugin in the preview window 324. However, with this solution, the user may not be able to see the preview on the preview window 324. Thus, the user will be able to view information regarding the application (e.g., how the application with the plugin will appear, etc.) until the application is built. For instance, in FIG. 3, the dependency library 326 of the application builder does not contain the dependencies 312 of the text box 306. Accordingly, the preview window 324 of the application builder will not be able to show the text box 306, and the user may use a place holder element in the screen preview to temporarily show the intended position of the text box. However, the place holder element may not accurately reflect in the preview window 324 how the text box 306 should appear.

Conventionally, the issue may be addressed by limiting the function of the plugin to only supported dependencies (e.g., if the plugin contains feature A and feature B, and the low-code application builder only supports a dependency of feature A, the function of the plugin may be limited to only feature A). However, the functionality of the plugin will be limited, and this approach may affect the operation of the plugin and/or cause the plugin to operate contrary to the main function of the plugin.

Conventionally, the issue may be addressed by rebuilding or updating the low-code application builder to include dependencies of all new components in the plugin. However, this solution is very burdensome for the owner/manager of the low-code application builder to rebuild/update the low-code application builder every time there is a new plugin. Further, this approach will also delay the application development process, since the low-code application builder is updated or rebuilt before the user uses the plugin.

Thus, provided here are a system and method for utilizing plugins in a low-code application builder. In particular, instead of building the plugin in the form of programming code and storing the dependencies and images in the application builder, the system may build a package (including all metadata such as the dependencies, the images, etc.) and a low-code application builder to load the package and generate, in real time or near real time, a plugin based on the package.

The application builder may be compatible with any plugin. That is, any user (e.g., vendors, in-house developers, etc.) may build their own plugins while collaborating on a same project via the same platform. Further, the application builder may not need to include plugin-related data (e.g., dependencies, images, etc.). That is, the application builder may have a smaller size and less failure risk. Furthermore, the application builder may dynamically load and build the plugin only when required, providing a more efficient application builder. The burden of the application builder manager/administrator may be reduced, as the manager/administrator does not need to rebuild or update the application builder to include dependencies of new components every time a new plugin is to be used.

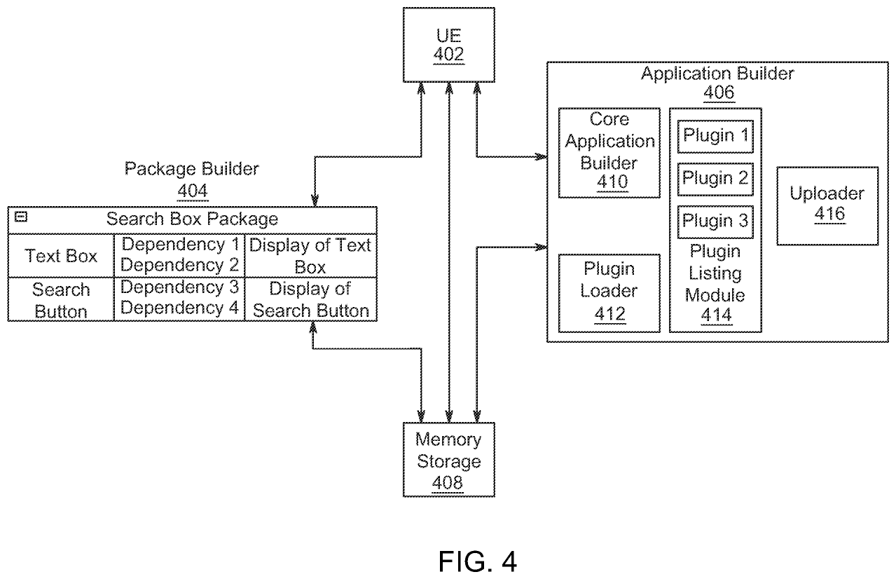

FIG. 4 is a diagram of a low-code application system, according to an embodiment. The system may include a UE 402, a package builder 404, an application builder 406, and a memory storage 408. The UE 402 may be communicatively coupled to the package builder 404 and the application builder 406. The package builder 404 may be communicatively coupled to the application builder 406. The application builder 406 may be communicatively coupled to the storage 408. The package builder 404 may include a search box package, including a text box and a search button, as well as their corresponding dependencies. The application builder 406 may include a core application builder 410, a plugin loader 412, a plugin listing module 414 listing a plurality of plugins (e.g., plugin 1 to plugin 3), and an uploader 416.

To create a new plugin, a user of the UE 402 may first access the application builder 406 and select an option to create a new plugin (e.g., by pressing a button presented in the application builder 406, etc.). Upon receipt of the user input to create a new plugin, the application builder 406 may direct the user to the package builder 404. In some embodiments, the user may directly access the package builder 404 without accessing the application builder 406. The package builder 404 may present a user interface(s) (UI) to allow the user to define the plugin (e.g., choose intended features, design the outlook of each element, etc.).

The package builder 404 may generate (i.e., compile, build, etc.) a package based on the user's input, the user's input including selections and/or parameters for defining/creating the plugins. The package may include metadata (e.g., dependencies, images of the elements, etc.) defining the plugin. The package builder 404 may send the package to the uploader 416 of the application builder 406. In some embodiments, the package builder 404 may send the package to the UE 402, and the user may manually upload the package to the application builder 406 via the uploader 416 of the application builder 406. The uploader 416 of the application builder 406 may receive the package and determine (e.g., by comparing the information in the package with the information in a plugin listing module) whether or not the plugin defined by the package is a new plugin.

Based on determining that the plugin is a new plugin, the uploader 416 may add the title/name of the plugin, which may be defined by information in the package, into, for example, a list of plugins in the plugin listing module 414, and store the metadata (e.g., dependencies, images of the elements, etc.) of the package into the memory storage 408. Subsequently, the plugin listing module 414 may provide an updated list of plugins to the plugin loader 412. The plugin loader 412 may process the updated list of plugins and present the available plugins (e.g., in the form of a list in a GUI) in the application builder 406 to be selected by a user.

To preview a plugin, a user may select, from a GUI presented in a preview window of the application builder 406, a plugin to preview. The core application builder 410 may provide the user's selection to the plugin loader 412. The plugin loader 412 may determine which data is required for generating a plugin preview, and then retrieve, from the memory storage 408, the required data (e.g., images of each of the components/elements of the plugin, etc.). The plugin loader 412 may provide the retrieved data to the core application builder 410. The core application builder 410 may generate a plugin preview (e.g., by combining a plurality of component images, etc.) and present the plugin preview in the preview window (e.g., preview window 324).

To load a plugin, a user may select, from a GUI presented in the application builder 406, a plugin to build together with the application. That is, the user may select a plugin to be implemented with the low-code application. The user's selection may be provided to the plugin loader 412. Based on the user's selection, the plugin loader 412 may retrieve the metadata of the selected plugin from the memory storage 408, generate the selected plugin based on the metadata, and provide the generated plugin to the core application builder 410. The core application builder 410 may build the application along with the generated plugin.

To update a created plugin, the uploader 416 may receive (e.g., from the package builder 404, directly from a UE 402, etc.) a package including updated metadata and/or a request to update a. The uploader 416 may determine, from the received package, a type of update. Based on determining that the update is a label/naming update type, the uploader 416 may send an update request to the plugin listing module 414. Subsequently, the plugin listing module 414 may determine which plugin in the list of plugins should be updated, and update the title/label/name of the plugin. Further, the plugin listing module 414 may provide the updated information to the plugin loader 412 and core application builder 410. Based on determining that the update is an algorithm/operational update type, the uploader 416 may provide updated data to the memory storage 408 to replace the previously stored metadata with new metadata corresponding to the update.

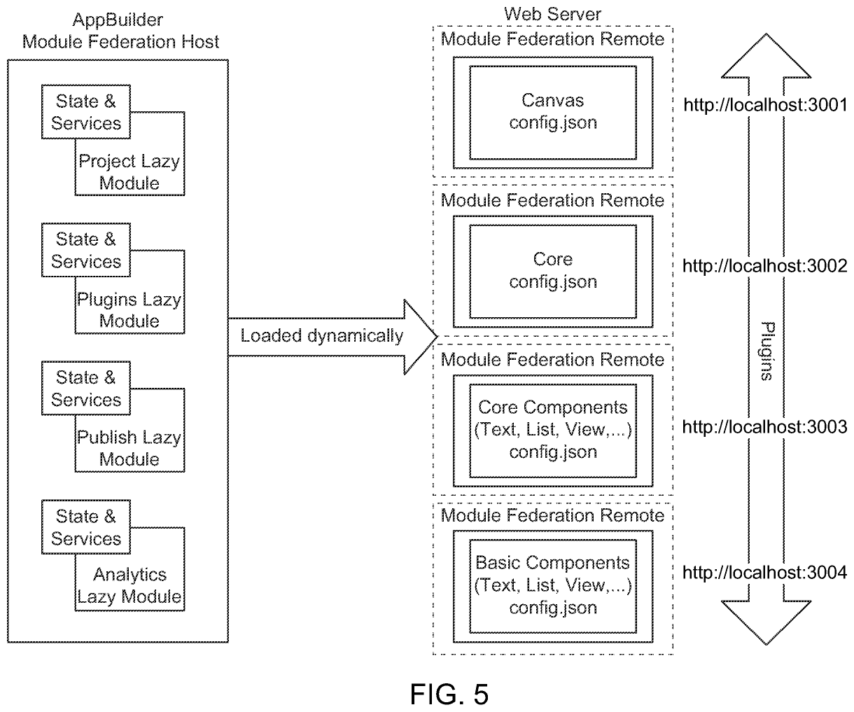

FIG. 5 is a diagram of dynamic loading, according to an embodiment. Remote modules may be hosted in a web server. The system may bundle the source code of the plugin with webpack to create a remote module and deploy the archive on a webserver. After the deployment, the application (AppBuilder) may download dynamically the code of the plugin with the URL of the deployed module.

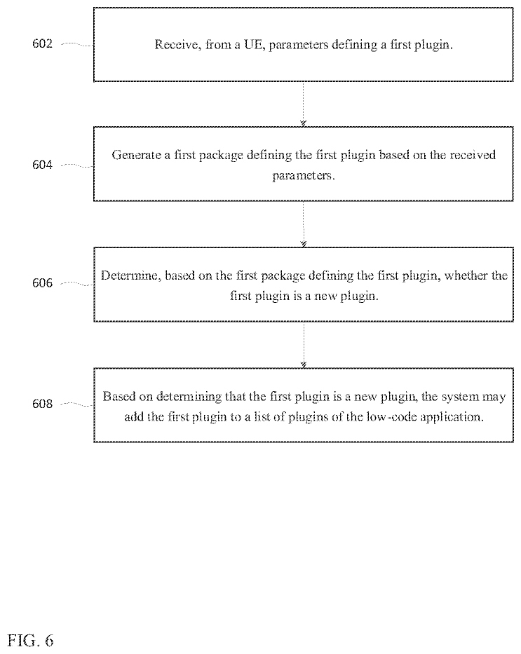

FIG. 6 is a flowchart of a method of implementing plugins in a low-code application, according to an embodiment. In operation 602, the system may receive, from a UE, parameters defining a first plugin. In operation 604, the system may generate a first package defining the first plugin based on the received parameters. The system may generate the first plugin based on the first package. In operation 606, the system may determine, based on the first package defining the first plugin, whether the first plugin is a new plugin. In operation 608, based on determining that the first plugin is a new plugin, the system may add the first plugin to a list of plugins of the low-code application.

In embodiments, any one of the operations or processes of FIGS. 3-6 may be implemented by or using any one of the elements illustrated in FIGS. 1 and 2.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of implementing plugins in a low-code application, performed by at least one processor, the method comprising:
receiving, from a user equipment (UE), parameters defining a first plugin;
generating a first package defining the first plugin based on the received parameters; and
generating the first plugin based on the first package.

2. The method of claim 1, further comprising:
determining, based on the first package defining the first plugin, whether the first plugin is a new plugin; and
based on determining that the first plugin is a new plugin, adding the first plugin to a list of plugins of the low-code application.

3. The method of claim 1, wherein the first package defining the first plugin comprises metadata corresponding to the first plugin.

4. The method of claim 3, wherein the metadata comprises at least one of:
at least one dependency corresponding to the first plugin; and
at least one element image of the first plugin.

5. The method of claim 1, further comprising:
receiving, from the UE, a selection to preview the first plugin;
generating a preview of the first plugin based on the received selection; and
displaying the preview of the first plugin in a preview window of the low-code application.

6. The method of claim 1, further comprising storing metadata corresponding to the first plugin in a memory corresponding to the low-code application based on determining that the first plugin is a new plugin.

7. The method of claim 6, further comprising:
receiving, from the UE, a selection to implement the first plugin with the low-code application; and
retrieving, from the memory, the metadata corresponding to the first plugin in response to the received selection.

8. The method of claim 1, further comprising:
receiving a request to update the first plugin, the request comprising a second package comprising updated metadata corresponding to the first plugin; and
determining a type of an update to be performed on the first plugin based on the second package.

9. The method of claim 8, further comprising, based on determining the type of the update to be a labelling update type, updating a label corresponding to the first plugin.

10. The method of claim 8, further comprising, based on determining the type of the update to be an operational update type, replacing, in a memory, previously stored metadata corresponding to the first plugin with the updated metadata corresponding to the first plugin.

11. A system for implementing plugins in a low-code application comprising:
at least one memory storing instructions; and
at least one processor configured to execute the instructions to:
receive, from a user equipment (UE), parameters defining a first plugin;
generate a first package defining the first plugin based on the received parameters; and
generate the first plugin based on the first package.

12. The system of claim 11, wherein the at least one processor is further configured to execute the instructions to:
determine, based on the first package defining the first plugin, whether the first plugin is a new plugin; and
based on determining that the first plugin is a new plugin, add the first plugin to a list of plugins of the low-code application.

13. The system of claim 11, wherein the first package defining the first plugin comprises metadata corresponding to the first plugin.

14. The system of claim 13, wherein the metadata comprises at least one of:
at least one dependency corresponding to the first plugin; and
at least one element image of the first plugin.

15. The system of claim 11, wherein the at least one processor is further configured to execute the instructions to:
receive, from the UE, a selection to preview the first plugin;
generate a preview of the first plugin based on the received selection; and
display the preview of the first plugin in a preview window of the low-code application.

16. The system of claim 11, wherein the at least one processor is further configured to execute the instructions to store metadata corresponding to the first plugin in a memory corresponding to the low-code application based on determining that the first plugin is a new plugin.

17. The system of claim 16, wherein the at least one processor is further configured to execute the instructions to:
receive, from the UE, a selection to implement the first plugin with the low-code application; and
retrieve, from the memory, the metadata corresponding to the first plugin in response to the received selection.

18. The system of claim 11, wherein the at least one processor is further configured to execute the instructions to:
receive a request to update the first plugin, the request comprising a second package comprising updated metadata corresponding to the first plugin; and
determine a type of an update to be performed on the first plugin based on the second package.

19. The system of claim 18, wherein the at least one processor is further configured to execute the instructions to, based on determining the type of the update to be a labelling update type, update a label corresponding to the first plugin, and
based on determining the type of the update to be an operational update type, replace, in a memory, previously stored metadata corresponding to the first plugin with the updated metadata corresponding to the first plugin.

20. A non-transitory computer-readable storage medium storing instructions that, when executed by at least one processor, cause the at least one processor to:
receive, from a user equipment (UE), parameters defining a first plugin;
generate a first package defining the first plugin based on the received parameters; and
generate the first plugin based on the first package.
